(19) United States
(12) Patent Application Publication
(10) Pub. No.: US 2011/0241446 A1
(43) Pub. Date: Oct. 6, 2011

(54) IRREVERSIBLE CIRCUIT ACTIVATION SWITCH

(75) Inventor: Gary R. Tucholski, North Royalton, OH (US)

(73) Assignee: BLUE SPARK TECHNOLOGIES, INC., Westlake, OH (US)

(21) Appl. No.: 13/075,620

(22) Filed: Mar. 30, 2011

Related U.S. Application Data
(60) Provisional application No. 61/318,961, filed on Mar. 30, 2010.

(51) Int. Cl. H01H 33/59

(52) U.S. Cl. 307/139

(57) ABSTRACT

An electrical device is provided, including a substrate, an electrical component on the substrate, and a battery on or integrating the substrate for providing electrical energy to said electrical component. An open switch prevents electrical communication between the electrical component and the battery while open. A circuit activating component is adapted to irreversibly close the open switch to thereby establish a permanent electrical circuit between the electrical component and the battery.

### CROSS-REFERENCE TO RELATED APPLICATIONS

This application claims the benefit of U.S. provisional application Ser. No. 61/318,961, filed on Mar. 20, 2010, which is incorporated herein in its entirety by reference thereto.

### BACKGROUND OF THE INVENTION

For the past one hundred years or so, scientists have been making Carbon/Zinc portable power sources for various applications. In the early days of portable power, these power sources were very large compared to today's standards. For example, the very popular “Igniter Cell” made by Eveready was about 3″ diameter and about 9″ tall and was used in many applications such as radios, buzzers, Xmas lighting, etc. These large cells, as well as some smaller versions, such as the famous Eveready #6 (about 2″ dia.×6″ tall) and the smallest unit cell of the day, the #950 (D size), were commonly made into battery packs with voltages exceeding 40 volts in some applications. These were similar in size, and even larger, than today's car batteries, for uses in lighting devices, radios and car ignition systems. In the mid 1900's, with the advent of advanced electronics such as the transistor, the electrical requirements for portable power sources were drastically reduced. Consequently, cell sizes could also be reduced to include C's, AA's, and AAA's, and even small button cells. This power reduction has continued into the twenty-first century, where applications such as smart labels, smart credit cards, sensors, data loggers, novelty devices such as greeting cards and badges, etc., now require a maximum current of several milliamperes, with many applications requiring as little as a few microamperes at about 1.5-3.0 volts. These applications also have the requirement that the power sources be flat and very thin to maintain their low profiles and portability.

In the past twenty-five years, various approaches for making thin, flat cells and batteries were attempted by numerous scientists and corporations. These include the widely known instant film battery pack developed by Polaroid. This battery pack was used in each package of Polaroid instant film. This allowed Polaroid to have a fresh battery in the camera each time the user placed a new pack of film in the camera. This high cost battery with multiple layers and a metal foil laminate package is a high voltage, high current battery, capable of igniting flash bulbs and powering motors, for example, and is not a realistic competitor of the new thin low cost batteries that are needed. In addition to Polaroid, others have tried to develop thin batteries in various electrochemical systems.

Co-pending U.S. application Ser. Nos. 11/110,202 filed on Apr. 20, 2005 and 11/378,520 filed on Mar. 17, 2006 incorporated herein by reference, discuss new designs and methods of manufacture of a flat cell and battery.

With the growing market needs for low cost, low capacity thin flat cells, it would be beneficial to produce a thin, flat, printable flexible cell that is versatile and inexpensive to mass-produce. Printable, disposable thin cells that are well suited for low-power and high-production volume applications would be useful, especially if they offer adequate voltage, sufficient capacity, and low-cost solutions. Conventional low-profile batteries typically have few of these attributes, if any. Still, it is possible to utilize a low-profile battery (i.e., a coin cell or button cell), or any other type of battery, in the instant electrical device.

There are many electrical devices that are powered with batteries. In some of these applications, the batteries are replaceable and in other cases the batteries are wired into the circuit. In both types, the manufactures are always concerned that the battery capacity will be depleted prior to the customer using the device. In the case of the circuit with replaceable batteries, the circuit usually has an off/on switch. This switch could be inadvertently activated, thus consuming power until it is turned off. If this happens in the shipping process and/or in the store prior to being purchased, it is very likely that the batteries capacity will be completely consumed, thus requiring the consumer to replace the batteries. To protect this type of device, the manufactures could package the batteries outside of the device, thus requiring a larger package and requiring the consumer to install the batteries. One conventional way to correct this problem is that manufactures insert an insulating strip between the circuit contact and the battery. However, an insulating strip can be manually re-inserted between the circuit contact and the battery to thereby break the circuit. In the case of an electronic circuit that contains an integrated-circuit (“IC”) chip, the chip even in “sleep mode” draws current, although very small, that presents another challenge of maximizing the run time for the end user. Complicating matters even more is that these circuits are usually powered by very small size cells with capacities of only microamp hours to milliamp hours. These power sources are usually hard wired and/or integrated into the circuit, such that the low cost and simple insulating strip cannot be used.

### SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with one aspect of the present invention, an electrical device comprises a substrate and an electrical component on the substrate and an electrical contact. A battery is on or integrating the substrate for providing electrical energy to said electrical component. The flat battery comprises an electrode. An open switch is electrically connected between the electrical contact and the electrode, said switch preventing electrical communication between the electrical contact and the electrode while open. A conductor is adapted to irreversibly close the open switch to thereby establish a permanent electrical circuit between the electrical contact and electrode.

In accordance with another aspect of the present invention, an electrical device comprises a substrate and an electrical component on the substrate and an electrical contact. A flat battery is on or integrating the substrate for providing electrical energy to said electrical component. The flat battery comprises an electrode. An electrical coupler assembly is electrically connected between the electrical contact and the electrode. The electrical coupler assembly comprises a physical gap preventing electrical communication between the electrical contact and the electrode. A conductor is adapted to irreversibly electrically bridge the physical gap to thereby establish a permanent electrical circuit between the electrical contact and electrode.

In accordance with yet another aspect of the present invention, an electrical device comprises a first substrate and a second substrate arranged in a covering relationship over at least a portion of the first substrate. An electrical component is on the first substrate and an electrical contact. A flat battery is on or integrating the first substrate for providing electrical energy to said electrical component. The flat battery comprises an electrode. An open switch is electrically connected between the electrical contact and the electrode, said switch preventing electrical communication between the electrical contact and the electrode while open. The open switch is physically accessible via the second substrate. A circuit activating component is configured to permanently and irreversibly close the open switch to thereby establish a permanent electrical circuit between the electrical contact and electrode.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 illustrates a top view of an example electrical device comprising an electrical component and a flat battery;

FIGS. 2A-2B illustrate a sectional view taken along line A-A of FIG. 1 of one embodiment of an open switch in an open condition and in a closed condition, respectively;

FIGS. 3A-3B are similar to FIGS. 2A-2B, but illustrate another embodiment of an open switch in an open condition and in a closed condition, respectively;

FIGS. 4A-4B are similar to FIGS. 2A-2B, but illustrate yet another embodiment of an open switch in an open condition and in a closed condition, respectively; and

FIGS. 5A-5B are similar to FIGS. 2A-2B, but illustrate still yet another embodiment of an open switch in an open condition and in a closed condition, respectively.

### DETAILED DESCRIPTION OF THE PREFERRED EMBODIMENTS OF THE INVENTION

In applications where the batteries are hard wired into a circuit and there is not a switch, the current begins to flow at the time that the circuit is completed. Typically this type of circuit could include a display, IC chip, sensor, antennae (e.g., RFID antenna), and a low capacity power source such as a flat printed battery or low-profile battery. Even though the circuit may be in sleep mode, the IC chip still requires a relatively small amount of electrical current (e.g., micro amperes) to stay functional. Over time, this small current on a 24/7 basis consumes a large portion of the batteries capacity, thus minimizing the functional life of this circuit to the user. The time it takes for the consumer to receive this device varies from manufacturer to manufacturer depending on the manufacturing system, distribution system, and inventory levels. Even after the end user gets this electrical device, more than likely it will be not used for various periods of time, due to many reasons, thus more time to consume power without any useful life.

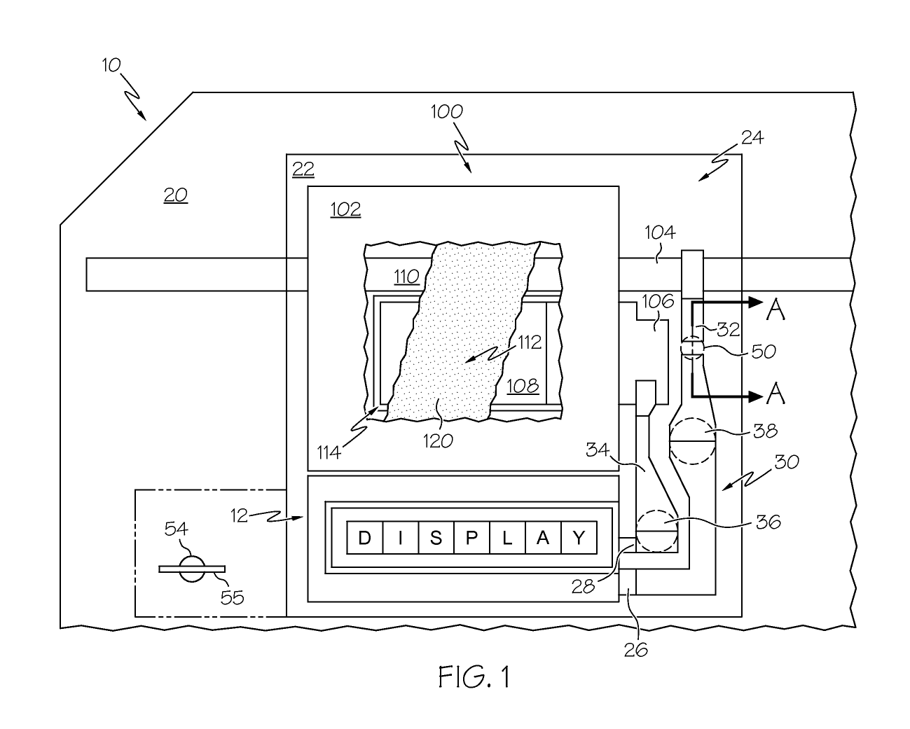

In an effort to correct this power loss problem, it is proposed that an electrical device using these electrical circuits include an irreversible one time switch that can be activated when the consumer wants to begin using the device. These electrical devices could include smart cards, tracking labels, all types of sensors in many types of packages. It is proposed that this can be achieved in a number of different manners. For the purpose of this application, a smart card device with a display will be used as the example electrical device, but the concept is not limited to only this application. For example, FIG. 1 illustrates a portion of a smart card electrical device 10 with an electrical component 12 in the form of a display, and a battery 100 for providing electrical energy to the electrical component 12. The smart card electrical device 10 includes at least one substrate 20 formed of various materials, and can include a single-layer or multi-layer substrate. As described herein, the substrate 20 can be the top layer or surface of the smart card electrical device 10, though it is also conceivable that the substrate 20 can be an independent layer located on the smart card electrical device 10, such as on the top layer or surface of the smart card electrical device 10. Additionally, the smart card electrical device 10 includes a second substrate 22 (which can include a single-layer or multi-layer substrate) arranged over at least a portion of the substrate 20. The second substrate 22 may cover less than all of the substrate 20, or substantially all of the substrate 20. As shown in FIG. 1 to provide greater clarity, the second substrate 22 is shown as a substantially transparent layer so that the various elements covered thereby can be seen, though it is understood that the second substrate 22 can also be translucent or opaque. Herein, the battery is generally described as a flat battery. However, it is understood that it is possible to utilize a low-profile battery (i.e., a coin cell, button cell, or the like), or any other type of power supply (including RFID wireless power supply), in the described electrical device 10.

Various methods can be used to manufacture flat batteries. In one example, the electrochemical cells (i.e., batteries) are typically printed and/or laminated on a continuous, flexible substrate web, and may be formed into a roll or the like. The individual batteries can be removed from the roll, such as one at a time. For example, the batteries can be cut from the roll, and/or perforations of the flexible substrate roll can be provided for easy tear off. In addition, the batteries can further be manufactured in an integrated process with one or more electrical components, such as an antenna, display, and/or a processor, for example. The multiple facets of this application could be used in the total package described and/or they could be used individually or in any combination.

As used herein, unless otherwise explicitly indicated, all percentages are percentages by weight. Also, as used herein, when a range such as “5-25” (or “about 5-25”) is given, this means, for at least one embodiment, at least about 5 and, separately and independently, not more than about 25, and unless otherwise indicated, ranges are not to be strictly construed, but are given as acceptable examples. Also herein, a parenthetical range following a listed or preferred value indicates a broader range for that value according to additional embodiments of the application.

The present application relates to thin, printed electrochemical cells and/or batteries comprising a plurality of such cells. Such cells each typically include at least a first electrode including a first electrochemical layer (e.g., a cathode), a second electrode including a second electrochemical layer (e.g., an anode), and an electrolyte that interacts with the electrodes to create an electrical current. All of the first and second electrodes and the electrolyte are typically contained within some structure which provides an external electrical access to the electrodes for providing an electrical current supply to some device.

One method of mass-producing such cells includes depositing aqueous and/or non-aqueous solvent inks and/or other coatings in a pattern on a special substrate, such as a laminated polymeric film layer, for example. The depositing can be by means of, for example, printing electrochemical inks and/or laminating a metallic foil, such as zinc foil, for example, on one or more high-speed web rotary screen printing presses, especially if the desired volumes are very high. If volumes are relatively lower, say in the quantities of only about several million or less, then relatively slower methods such as web printing with flat bed screens could be appropriate. If the volumes are even lower, such as hundreds or thousands, then a sheet-fed flat bed printing press may be utilized, for example. Still, various printing methods can be used for various desired quantities.

After the inks are printed and/or the solids have been properly placed, the cells can be completed (e.g., sealed, die cut, stacked and/or perforated and wound into a roll, or stacked if sheets are used on a printing press). This cell manufacturing process can also be utilized for integrating one or more individual cells with an actual electronic application, or into batteries comprising multiple cells connected in series or parallel, or some combination of the two. Examples of such devices and corresponding processes will be described later, but many additional embodiments are also contemplated.

As discussed above, the battery may be described as a printed, flexible, and thin electrochemical cell. Such a cell can include, for example, a lower film substrate that can utilize a special polymer laminate that has special features, possibly including, for example, a high moisture barrier layer in the center that is surrounded by polymer films on both sides. Furthermore, one or both outside surfaces can be made to be print receptive for printing information, logos, instructions, identifications, serial numbers, graphics, or other information or images, as desired.

Depending on which construction of this battery is used, the inner ply of the substrate could also feature a heat-sealing layer that might be co-extruded on the side opposite the barrier coating.

In addition, a portion of the inner surface of a lower substrate layer of a cell of at least some embodiments could utilize a cathode current collector, such as carbon, for example, printed or coated or otherwise applied on a portion of the film substrate. At an outside contact area of this collector can also be printed a layer of a relatively highly conductive ink, such as carbon, gold, silver, nickel, zinc, or tin, for example, to improve the conductivity to the application connection, if desired. However, if the battery application is used for relatively low current requirements, then the higher conductive layer contact material, or even the current collector, may not be utilized for one or both electrodes.

For at least some embodiments, a water-based ink electrochemical layer is printed as the cathode. Such a cathode layer can include, for example, manganese dioxide (MnO₂), carbon, and a polymer binder. Other formulations for the cathode layer can also be utilized with or without any of these materials. If a cathode collector layer is used, which may or may not form a portion of the cathode layer, the cathode electrochemical layer will be printed on at least a portion of the cathode current collector, which is printed or otherwise applied first to the substrate.

Regarding the anode, in an off-line operation, a dry-film adhesive layer, possibly using a release liner, can be applied to the zinc foil. The zinc foil can then be laminated to the base substrate. Additionally, the anode layer could be applied by printing a zinc ink onto the substrate or on top of a collector, such as carbon. Where carbon is used, it could be printed in the same station as the carbon collector used for the cathode.

Optionally, printed over one or both the anode and cathode, is a starch ink or similar material. The starch ink can act as an electrolyte absorber to keep the electrodes “wet” after an aqueous electrolyte solution is added to the cell. This starch ink could also include the electrolyte salts and the water used for the cell reaction. A paper layer over the anode and cathode could be used in place of the printed starch. In at least one embodiment, the construction of the printed starch layer with the addition of the aqueous electrolyte could be replaced, for example, by a printable viscous liquid (which could include a gel, or some other viscous material) that effectively covers at least a portion of each electrode. One such printable gel is described in United States Patent Publication 2003/0165744A1, published on Sep. 4, 2003, and incorporated herein by reference. These viscous formulations could, for example, utilize the electrolyte formulas and concentrations previously discussed.

For some embodiments, after the two electrodes are in place, with or without the starch layer(s), a cell “picture frame” can be added. This could be done using a number of different methods. One method is to print this cell picture frame with a dielectric ink, for example. Another method is to utilize a polymer sheet or a laminated polymer sheet that includes adhesive layers, that is stamped, die cut, laser cut or similar methods to form the appropriate “pockets” (inner space or spaces) to house materials of each unit cell as well as to expose the electrical contacts to connect the device.

To ensure good sealing of the picture frame to the substrates, and to provide good sealing of the contact feed-through (providing an electrical pathway from the cell inside to the cell exterior), a sealing or caulking adhesive could be printed over the contact feed-through and the substrate, such as in the same pattern as the cell frame, for example, prior to the frame being printed or prior to the polymer sheets being inserted, for example.

This sealing or caulking material could be pressure sensitive, and/or heat sensitive, for example, such as Acheson Colloids' PM040, for example, or any other type of material that would facilitate sealing to both surfaces.

After the dielectric picture frame is printed and dried and/or cured, a heat sensitive sealing adhesive can be printed on top of the frame to allow good sealing of the top substrate to the cell frame. This cell picture frame could also comprise a polymer film or a laminated film of about 0.015″ thick (range of about 0.003″-0.050″) that is pre-punched and then laminated in registration to match the preprinted caulking adhesive layer described above.

Zinc chloride (ZnCl₂) can be chosen as the electrolyte, for at least some embodiments, in the concentration range of about 18%-45% by weight, for example. In one example, about 27% may be preferred. The electrolyte can be added, for example, to the open cell. To facilitate processing on the line, this electrolyte, or a different electrolyte, could be thickened with, for example, CMC at about a level of about 0.6 wgt % (range of about 0.05%-1.0%).

Other useful electrolyte formulations, such as ammonium chloride (NH₄Cl), mixtures of zinc chloride (ZnCl₂) and ammonium chloride (NH₄Cl), zinc acetate (Zn(C₂H₂O₂)), zinc bromide (ZnBr₂), zinc fluoride (ZnF₂), zinc tartrate (ZnC₄H₄O₆.H₂O), zinc per-chlorate Zₙ(ClO₄)₂.6H₂O), potassium hydroxide, sodium hydroxide, or organics, for example, could also be used.

Zinc chloride may be the electrolyte of choice, providing excellent electrical performance for ordinary environmental conditions normally encountered. Likewise, any of the above mentioned alternative electrolytes, among others, could be used in concentrations (by weight), for example, within the range of about 18%-50%, with the range of about 25%-45% used for at least some other embodiments. Such compositions could also provide acceptable performance under ordinary environmental conditions. When zinc acetate is used to achieve improved low temperature performance for low temperature applications, the zinc acetate concentration in the range of about 31-33, is often acceptable, although ranges of about 30-34, about 28-36, about 26-38, and even about 25-40, weight percent, could also be utilized.

The use of electrolytes other than of zinc chloride can provide improved cell/battery electrical performance under some differing environmental conditions. For example, about 32% by weight zinc acetate (F.P.—freezing point—about 28° C.) exhibits a lower freezing point than about 32% by weight zinc chloride (F.P. about −23° C.). Both of these solutions exhibit a lower freezing point than of about 27% zinc chloride (F.P. about −18° C.). Other zinc acetate concentrations, e.g. about 18-45 or about 25-35 weight percent, also exhibit reduced freezing points. Alternatively, potassium hydroxide (KOH) could be used as an electrolyte to provide improved cell/battery electrical performance under some differing environmental conditions. The cell performance could be greatly enhanced due to the much higher conductivity of the KOH electrolyte. For example, a good working range of KOH would be concentrations (by weight) within the range of about 23%-45%.

Use of such electrolyte formulations as substitutes for zinc chloride, or in various mixtures used in cells, can allow for improved performance at low temperatures. For example, it has been found that the use of an about 32% zinc acetate electrolyte substantially improves low temperature (i.e. below about −20° C.) performance of a voltaic cell. This type of electrochemical cell performance improvement at low temperature can be utilized in the growing business of battery assisted RFID tags, for example, and/or other transient (transportable) electrically operated devices, such as smart active labels and temperature tags, for example, which may be used in cold environments.

For example, many products that are shipped today, such as food products pharmaceuticals, blood, etc, may require low temperature storage and shipping conditions, or even low temperature operation. To ensure safe shipment of such goods, these items can be tracked with RFID tags, sensors, and/or displays. These tags and/or labels might require electrochemical cells and/or batteries to operate effectively at temperatures at, or even below, −20° C., such as at about −23° C., about −27° C., or even at about −30° C. or less.

The upper substrate of a cell package could utilize a special laminated polymeric film, which has an edge that extends beyond the internal cell/battery components onto the cell frame. The upper layer is sealed around the edges of the cell frame by means of a pressure sensitive adhesive (PSA), and/or with the heat sensitive sealing adhesive that was previously printed, thus confining the internal components within the cell frame.

The above-described constructions can be wet cell constructions; however, using a similar cell construction, the battery could be also be made into a reserve cell construction, which has the benefit of providing extended shelf life prior to the application of a liquid. The printable, flexible, zinc chloride thin cell can be made environmentally friendly.

The devices for which this technology can be used are extensive. Devices that utilize relatively low power or a limited life of one to three years, and possibly longer, could function utilizing a thin cell/battery of the type described herein. The cell, as explained in the above paragraphs and below, can often be inexpensively mass-produced so that it can be used in a disposable product, for example. The low cost allows for applications that previously were not cost effective.

The electrochemical cell/battery according to the application might have one or more of the following advantages:

Relatively thin;

Flat, and of relatively uniform thickness, where the edges are of about the same thickness as the center;

Flexible;

Many geometric shapes are possible;

Sealed container;

Simple construction;

Designed for high speed and high volume production;

Low cost;

Reliable performance at many temperatures;

Good low temperature performance;

Disposable and environmentally friendly;

Both cell contacts provided on the same surface;

Ease of assembly into an application; and

Capable of being easily integrated in a continuous process at the same time that the electronic application is being made.

The above was a general description of various cell constructions according to some embodiments of this application, and further details utilizing drawings follow below. Cell and battery production processes for cell printing and assembly also will be described as well.

In one example, such as where relatively high speed, high output manufacturing is contemplated, such as 50 linear feet per minute or another relatively high speed, multiple webs can be used. It is to be understood that the multiple webs can be generally continuous, and can be utilized with known web manufacturing equipment. A first web can be relatively thin, such as ˜0.001″-0.010″ and preferably about 0.003-0.006″, flexible base substrate including a multi-ply laminated structure or single ply material. In one example, the multi-ply structure can include five layers. Alternatively, the single ply material can include various materials, such as Kapton, polyolifins or polyester. Additionally, if the 0.001″ layer is too thin to handle efficiently on the printing press and/or on other operations, then a thicker throw away support layer with a low tact pressure sensitive adhesive layer could be laminated to the thin substrate layer. Also, this 0.001″ substrate layer could be made from more than one ply with a very thin oxide layer which performs as a water barrier on the inside surfaces. After the printing and assembly operations are completed, then the throw away support layer could be removed.

A second web can be a relatively thick laminated structure including a PVC or Polyester film that is about 0.005-0.030″ thick, and preferably about 0.010-0.015″ thick. The second web can have a layer of pressure sensitive adhesive at about 1-5 mils thick on one or both sides. After this laminated structure of the second web is completed, it can be applied to the first web. In addition or alternatively, the second web can be pattern cut using any type of mechanical means to allow for cavities for the cells active materials as well as an optional cavity for the cell/battery contacts. A third web can be a relatively thin laminated structure the same and/or similar to the first web. The completed three web structure may have a pressure sensitive adhesive on either side to allow the individual device assembly to be applied as a label. The cell/battery may be of the thin cell type, such as disclosed in co-pending application Ser. No. 11/110,202, filed on Apr. 20, 2005 and incorporated herein by reference, and/or the cells disclosed in co-pending application Ser. No. 11/378,520, filed on Mar. 17, 2006, and also incorporated herein by reference.

The various conductive inks described herein could be based on many types of conductive materials such as carbon, silver, gold, nickel, silver coated copper, copper, silver chloride, zinc and/or mixtures of these. For example, one such material that shows useful properties in terms of conductivity and flexibility is Acheson Colloids silver ink (Port Huron, Mich.) PM046. Furthermore, various circuits, electrical pathways, antennas, etc. that might be part of the printed circuitry can be made by etching aluminum, copper or similar type metallic foils that are laminated on a polymer such as Kapton or polyester substrate. This could be done with many types (sizes and frequencies) of pathways and/or antennas whether they are etched or printed.

A thin printed flexible electrochemical cell includes a printed cathode deposited on a printed cathode collector (e.g., a highly conductive carbon cathode collector) with a printed or foil strip anode placed adjacent to the cathode. Electrochemical cells/batteries of this type are described in U.S. patent application Ser. No. 11/378,520, the disclosure of which is incorporated herein by reference. The electrochemical cell/battery can also include a viscous or gelled electrolyte that is dispensed onto a separator that covers all or part of the anode and cathode, and a top laminate can then be sealed onto the picture frame. This type of electrochemical cell was designed to be easily made by printing (e.g., through use of a printing press), and allows, for example, for the cell/battery to be directly integrated with an electronic application.

In the illustrated embodiment of FIG. 1, the flat battery 100 is shown in a top, partial detail view. Though not explicitly stated, the flat battery 100 can include any of the battery structure or methodology described herein. The flat battery 100 is on or integrating the substrate 20 (i.e., first substrate) of the smart card electrical device 10 as a lower layer. That is, the flat battery 100 can be disposed directly or indirectly on the substrate 20, and/or can integrate the substrate 20 into the battery construction. In various examples, the flat battery 100 can be manufactured (i.e., printed) directly or indirectly on the substrate 20, or can even be separately manufactured (wholly or partially) and then attached directly or indirectly to the substrate 20. In one embodiment, the substrate 20 is a laminated film. The flat battery 100 further integrates a top layer 102 (which can also be a laminated film) arranged in a covering relationship over the substrate 20 and the various battery elements as well as the electrical device 10. It is conceivable that the second substrate 22 could even be used as the top layer of the battery 100. An extended area 24 of the electrical device 10 has a negative electrode 104, which can include a negative electrode extension. This extension is illustrated in the case where the negative electrode is a foil that is a continuation of the anode foil. In the case where the anode is printed zinc, then this extension can be printed silver. The positive electrode 106, which can similarly include a positive electrode extension, can be a silver printed contact on top of the carbon collector extension, or even just on top of the carbon collector. Additionally, the flat battery 100 includes a cathode layer 108 and an anode layer 110, each comprised of an electrochemical layer of a different composition that can interact through an electrolyte 112 to create an electrical current. To provide greater clarity, flat battery 100 in FIG. 1 is shown with a portion of the top layer 102 (e.g., top laminate) removed.

Prior to applying the cathode layer 108, a cathode collector 114 of highly conductive carbon is printed on the lower substrate 20 using another dried or cured ink. In at least one embodiment, on the large area part of the cathode collector 114, the cathode layer 108 is printed using an ink comprising manganese dioxide, a conductor such as carbon (e.g., graphite) for example, a binder, and water. The anode layer 110 can be printed with a conductive zinc ink, or be provided as a zinc foil PSA laminate, either of which can be made about 0.20″ wide and about 0.002″ (0.001″-0.010″) thick. After the electrode layers (cathode layer 108 and anode layer 110) are in place, a “picture frame” can be placed around the electrodes and act as a spacer. The picture frame can comprise a die cut polymer laminate sheet, such as a polyester or polyvinyl chloride (PVC) etc, and can be further provided with two layers of pressure sensitive adhesive. A top pressure sensitive adhesive (PSA) layer seals the second substrate 22 to the picture frame and a bottom PSA layer can be used to seal the bottom substrate 20 to the picture frame. In an alternative embodiment, where the battery 100 utilizes the second substrate 22 as the top layer as discussed above, element 102 could then represent the picture frame.

The picture frame assembly has a total thickness (excluding the thickness of the liners) of about 0.015″ (about 0.005″-0.50″). The picture frame can be placed on the lower substrate 20 after removing a bottom release liner so that the electrodes are centered within the frame. In some cases, to ensure a leak-free construction, a sealing and/or caulking adhesive, a heat sensitive sealant, and/or double sided PSA tape can be placed and/or printed on top of the anode layer 110 and on top of cathode collector 114 in an area that falls under the picture frame. The sealing adhesive can also be provided underneath the remainder of the picture frame.

As described herein, the electrochemical cell/battery can also include a viscous or gelled electrolyte. If the electrolyte is not part of the gelled coating, a cell electrolyte is provided to an absorbent material such as a “paper separator” 120 that covers or partially covers both electrodes. To provide greater clarity, the electrolyte separator layer 120 is shown with partial cutaways at both its top and bottom. The electrolyte can be an aqueous solution of ZnCl₂ at weight percent of about 26-27% (about 23%-43%) that could also contain a thickener, such as carboxymethylcellulose (CMC) or other similar materials at about 0.6% level (about 0.1%-2%). The electrochemical cell is completed by applying and sealing the second substrate 22 (top laminate layer), such as over the picture frame using the PSA and/or with a heat seal.

The batteries described above have a co-planar construction. A co-planar construction provides several advantages, in that they are easy to manufacture, provide consistent, reliable performance, and have their contacts on the same side of the cell/battery. Generally, one of the thin electrochemical cells described herein can provide about 1.5 volts. However, a number of cells can be electrically coupled together if higher voltages and/or high capacities are desired. For example, a 3 volt battery is obtained by connecting two 1.5 volt unit cells in series, although other voltages and/or currents can be obtained by using unit cells with different voltages and/or by combining different numbers of cells together either in series and/or in parallel. Thus, applications using greater voltages can connect unit cells in series, whereas applications requiring greater currents and/or capacities, unit cells can be connected in parallel, and applications using both can utilize various groups of cells connected in series further connected in parallel. Thus, a variety of applications that use different voltages and currents can be supported using a variety of unit cell and/or battery configuration.

As described herein, the smart card electrical device 10 is provided with an electrical component 12 powered by the flat battery 100. In various examples, the electrical component 12 can be any or all of an integrated circuit, radio, audio/visual components, etc. In one embodiment, the electrical component 12 is a display. Various types of displays can be utilized, ranging from simple lights to alphanumeric displays. In one example, the display can be an electrochromic display. The electrical component 12 is on the substrate 20 (i.e., first substrate) of the smart card electrical device 10, and could be covered by a portion of the second substrate 22 (such as where the second substrate 22 is transparent or translucent). Additionally, the electrical component 12 comprises at least one electrical contact 26 for enabling electrical power supply. As shown, the electrical component 12 comprises a pair of electrical contacts 26, 28, such as one positive contact and one negative contact. The electrical contacts 26, 28 can be a portion of the electrical component 12, and/or can even be provided together with the substrate 20.

The electrical device 10 can further comprise an electrical coupler assembly 30 electrically connected between the at least one electrical contact 26 and an electrode 104 of the flat battery 100. In the shown example, the electrical coupler assembly 30 can provide a first independent electrical connection 32 between the electrical contact 26 and the negative electrode 104, and a second independent electrical connection 34 between the other electrical contact 28 and the positive electrode 106. With a completed circuit, the electrical coupler assembly 30 enables electrical current to flow between the flat battery 100 and the electrical component 12. The electrical coupler assembly 30 can comprise printed electrically conductive traces, and/or even physical non-printed wires. The first and second independent electrical connections 32, 34 can be electrically coupled to the flat battery 100 and the electrical component 12 in various manners, such as by printing, solder, conductive adhesive, etc.

In addition or alternatively, the electrical coupler assembly 30 can further comprise one or more switches for turning the electrical component 12 (i.e., display) on and/or off. For example, an “on” switch 36 can be provided in-line with the second independent electrical connection 34 for selectively activating the electrical component 12. Similarly, an “off” switch 38 can be provided in-line with the first independent electrical connection 32 for briefly selectively shorting the battery 100 to quickly de-activate the electrical component 12. It is understood that either or both of the first and second independent electrical connections 32, 34 can include the switches 36, 38.

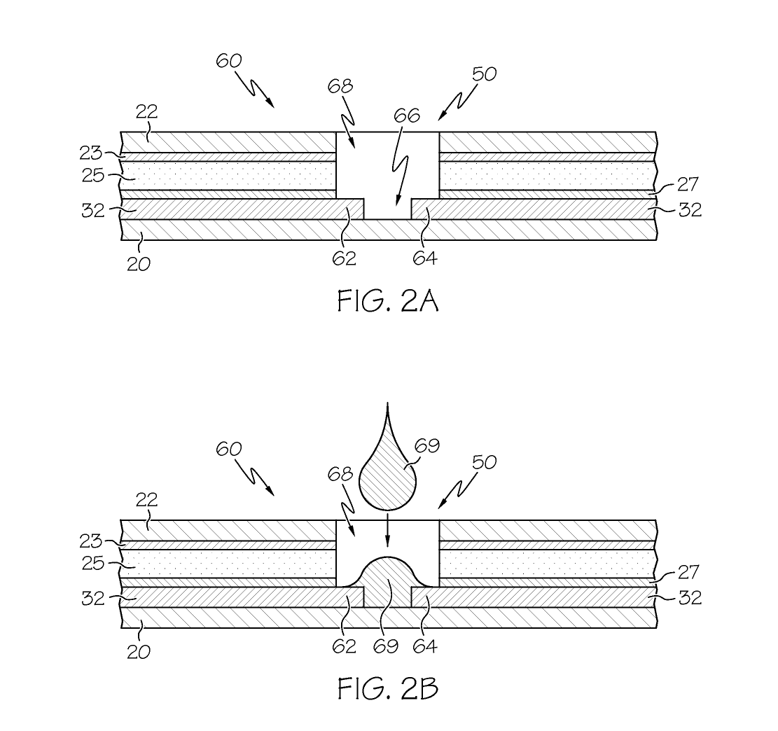

As described herein, in an effort to correct the power loss problem, the electrical device 10 includes an irreversible one time switch 50 that can be activated when the consumer wants to begin using the device. Generally, the irreversible one time switch 50 can be an open switch electrically connected between one of the electrical contacts and the associated connected electrode. The irreversible one time switch 50 prevents electrical communication between the electrical contact and the associated electrode while the irreversible switch 50 is open. For example, as shown in FIG. 1, the irreversible one time switch 50 can be disposed in-line with the first independent electrical connection 32 between the electrical contact 26 and the electrode 104, though it is understood that the irreversible switch 50 can be located variously. In one example, the irreversible one time switch 50 can be defined by a physical gap 66 (see FIG. 2A) in the electrical coupler assembly (i.e., a physical gap in the first independent electrical connection 32) that prevents electrical communication between the electrical contact 26 and the electrode 104.

Thus, the open switch physically prevents electrical communication between the electrical contact and associated electrode until corrective action is performed by a user to activate the electrical device 10. Accordingly, the electrical device 10 further comprises a circuit activating component 54 (illustrated schematically in FIG. 1) configured to permanently and irreversibly close the open irreversible switch 50 to thereby establish a permanent electrical circuit between the electrical contact and electrode. The circuit activating component 54 can be retained on the electrical device 10 by a pressure sensitive adhesive 55 or the like, or even separately packaged with the electrical device 10. Additionally, a portion of the second substrate 22 may or may not extend over the circuit activating component 54, and may even be selectively removable therefrom (e.g., via perforations, kiss cut, etc.) to provide access to the circuit activating component 54. It is understood that while the described permanent electrical circuit can be established between an electrical contact and associated electrode by the circuit activating component 54, electrical communication with the electrical component 12 may still be selectively interrupted by the switches 36, 38.

In one example, the circuit activating component 54 can comprise a conductor adapted to irreversibly close the open irreversible switch 50 to thereby establish a permanent electrical circuit between the electrical contact 26 and electrode 104. For example, the conductor can be adapted to irreversibly electrically bridge the physical gap to thereby establish the permanent electrical circuit. The irreversible one time switch 50 and circuit activating component 54 can be accomplished in a number of different ways, including any or all of the following embodiments.

Turning now to FIGS. 2A-2B, a first embodiment of the irreversible one time switch and circuit activating component is shown in partial sectional view taken along line A-A of FIG. 1 (i.e., sectional view through a portion of the first independent electrical connection 32). The irreversible one time switch 50 is shown in an open condition 60 in FIG. 2A, and in an irreversibly closed condition 61 in FIG. 2B.

Initially, various layers of the electrical device 10 shown in the sectional view will be described. Generally, the electrical device 10 has a bottom-most layer comprising the substrate 20, and a top-most layer comprising the second substrate 22, though it is understood that various other layers can be located under or over the substrates 20, 22. Additionally, a dielectric type spacer layer 25 can be disposed between the substrates 20, 22. The spacer layer 25 can be a physically placed or printed between the substrates 20, 22. When a common second substrate 22 (top layer) is used over the various elements of the electrical device 10, the spacer layer 25 can be beneficial to equalize heights among those various elements that may each have a different thickness. The various layers can be coupled together by adhesives or the like, such as by heat sensitive or pressure sensitive adhesive layers 23, 27. Though only two adhesive layers are shown, it is understood that various numbers of adhesive layers can be used between any of the various adjacent layers.

An additional illustrated layer is the first independent electrical connection 32. An open circuit is created by placing a small physical gap 66 between a first portion 62 and second portion 64 of the first independent electrical connection 32 in the circuit that connects to the battery 100. Thus, the physical gap 66 prevents electrical current flow between the first and second portions 62, 64 of the first independent electrical connection 32.

Above the gap there is there is a hole 68 in the package. For example, the hole 68 can extend through the second substrate 22 (or other top layer), and may also extend through other subjacent layers (e.g., layers 23, 25, 27). The hole 68 is located such that the irreversible switch 50 is physically accessible. For example, the illustrated hole 68 is located vertically above the irreversible switch 50 such that the irreversible switch 50 is physically accessible via the second substrate 22. The hole 68 is preferably at least as large as the physical gap 66, and often larger, though it can have various sizes. Additionally, the hole 68 is preferably sized to cooperate with the type of circuit activating component 54 provided with the electrical device 10 to permanently and irreversibly close the open irreversible switch 50. In another embodiment, the second substrate 22 can be provided as a continuous layer without the hole 68 pre-punched therethrough (it is contemplated that the hole 68 may or may not extend through the other layers 23, 25, 27). Instead, the user actively creates the hole 68 through the second substrate 22 (and possibly the other layers 23, 25, 27) when it is time to activate the irreversible switch 50. For example, the user can utilize a sharp object to pierce the second substrate 22 (and possibly the other layers 23, 25, 27) to create the hole 68. In one example, the conductive liquid 69 can be provided in a syringe or the like that can be used to pierce the second substrate 22 and then deliver the conductive liquid 69 directly into the physical gap 66. It is contemplated that the second substrate 22 could also be weakened about the area intended for the hole 68 to facilitate creating the hole 68. For example, the second substrate 22 could be pre-perforated or have a kiss-cut about the desired location of the hole 68.

When the consumer wants to begin using the electrical device 10, it can be easily activated by the following operation. When the smart card electrical device 10 is sold to the consumer, it includes a small amount of a conductive liquid 69 that can be non-removably inserted into the hole 68 to electrically close the open irreversible switch 50. Various types of conductive liquid 69 can be utilized, such as a conductive adhesive or a conductive ink. For example, the conductive ink can include at least one of carbon, gold, silver, nickel, zinc, or tin. Preferably, the conductive liquid 69 is a type that is curable so as to permanently remain within the hole 68. The conductive liquid 69 can be curable in various manners, such as via exposure to air, via chemical reaction, via exposure to UV radiation, etc.

In one example, the conductive liquid 69 can be provided as a conductive adhesive in a package of a two part conductive epoxy provided with the electrical device 10. The package can be made such that the consumer manually combines the hardener and conductive resin together inside of the package by squeezing the separate compartments and blending the two components together. When the two epoxy components are properly blended, the package can be trimmed at the top corner to allow the mixed conductive epoxy to be squeezed in the hole 68 (see FIG. 2B) above the physical gap 66. The conductive liquid 69 extends across the first and second portions 62, 64 of the first independent electrical connection 32 to thereby bridge the physical gap 66. After a short period of time, this conductive epoxy and/or other material cures to electrically close the open irreversible switch 50 and complete the irreversible circuit, thus making the smart card electrical device 10 useable. It is preferable that the conductive liquid 69 be curable so as to bond to the first and second portions 62, 64 and be non-removable therefrom. In another example, the conductive liquid 69 can be provided as a conductive ink, such as used in printing circuits. In this case it is only a one component material thus no mixing would be required, though some type of elevated temperature could be required to remove the ink's solvent.

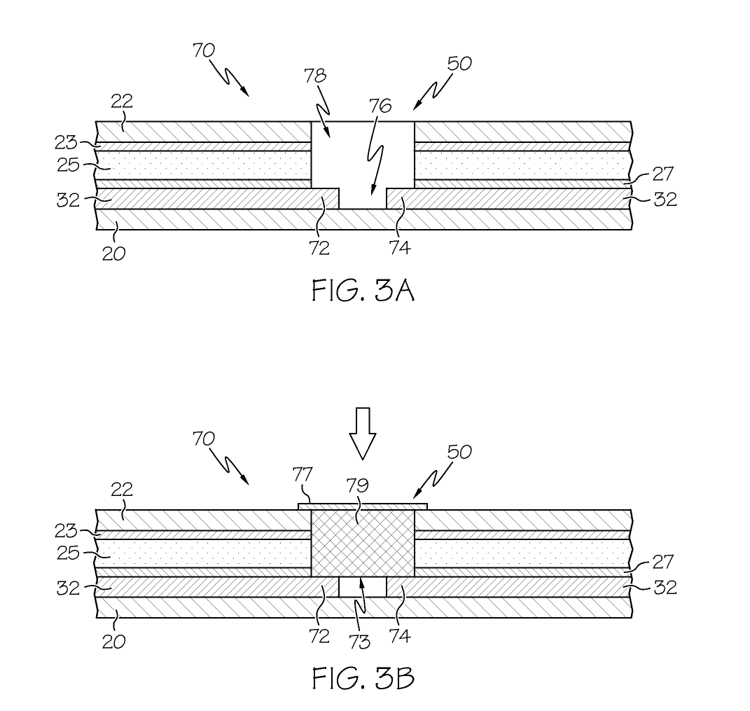

Turning now to FIGS. 3A-3B, another embodiment of the irreversible one time switch and circuit activating component is shown in partial sectional view taken along line A-A of FIG. 1. This embodiment of the irreversible one time switch 50 is shown in an open condition 70 in FIG. 3A, and in an irreversibly closed condition 71 in FIG. 3B.

The various substrates 20, 22 and layers 23, 25, 27 previously discussed herein with regards to FIGS. 2A-2B can be the same, though more or less, similar or different substrates and/or layers can also be used. Also, as before, an open circuit is created by placing a small physical gap 76 between a first portion 72 and second portion 74 of the first independent electrical connection 32 in the circuit that connects to the battery 100. Thus, the physical gap 76 prevents electrical current flow between the first and second portions 72, 74 of the first independent electrical connection 32. Also, above the gap there is there is a hole 78 in the package located such that the irreversible switch 50 is physically accessible. Alternatively, the second substrate 22 can be provided without the hole 78 pre-punched therethrough. Instead, the user actively creates the holes 78 through the second substrate 22 when it is time to activate the irreversible switch 50.

When the consumer wants to begin using the device, it can be easily activated by the following easy operation. When sold to the consumer, the smart card electrical device 10 includes a small conductive plug 79 that is configured to be non-removably inserted into the hole 78 to electrically close the open switch 50. The small conductive plug 79 can be provided separate from or coupled to the electrical device 10, such as schematically illustrated with the circuit activating component 54 of FIG. 1. The conductive plug 79 could even be provided in another independent hole through the second substrate 22 or other layer(s) while awaiting use.

In operation, the conductive plug 79 is non-removably inserted across the physical gap 76 to extend across the first and second portions 72, 74 of the first independent electrical connection 32 to thereby bridge the physical gap 76. Various types of conductive plugs 79 can be utilized. The conductive plug 79 can be entirely conductive or partially conductive, so long as it electrically bridges the first and second portions 72, 74 of the first independent electrical connection 32. In yet another example, the conductive plug 79 can include a conductive adhesive or coating thereon that provides the conductivity.

In use, the conductive plug 79 is non-removably inserted into the hole 78 to electrically close the open switch 50. The conductive plug 79 can be non-removable from the hole 78 in various manners. In one example, a portion of the conductive plug 79 can include a conductive PSA (Pressure Sensitive Adhesive). For example, the conductive plug 79 can include a conductive PSA on at least a portion of a bottom surface 73 thereof. In another example, the conductive plug 79 can be retained within the hole 78 by a conductive or non-conductive PSA 77 (such as an adhesive tape or the like) coupled to the second substrate 22 and placed in an at least partially covering relation over the conductive plug 79. The PSA 77 may even be the same as the previously described pressure sensitive adhesive 55 included with the circuit activating component 54 of FIG. 1. Additionally, the PSA 77 may provide a liquid or gas seal to protect the switch 50. In still yet another example, the conductive plug 79 can be non-removably retained into the hole 78 by interference fit or the like. Preferably, the conductive plug 79 has a cross-sectional geometry similar to that of the hole 78. In yet other examples, the conductive plug 79 can be non-removably retained into the hole 78 by mechanical fasteners, adhesives, etc. In still in another example, the conductive PSA could be applied at time assembly of the electrical device 100. In this case, the conductive PSA would be applied to electric connection 32 just prior to the openings 72 and 74.

When the consumer wants to activate the circuit, it is easily done by placing the conductive plug 79 into the hole 78 over the first and second portions 72, 74 of the open switch 50. If the conductive plug 79 uses a conductive PSA on the bottom surface 73, then that bottom surface 73 is placed over the first and second portions 72, 74 to bridge the physical gap 76. As described, the conductive PSA can also holds the conductive plug 79 in place. In the case where there is not a conductive PSA on the plug bottom, the hole 78 can be sealed with a PSA 77 (e.g., adhesive tape) or other adhesive. It is appreciated that this seal mechanism could also be used with the conductive plug 79 using the conductive PSA on the plug 79 and/or on the electrical connection 32.

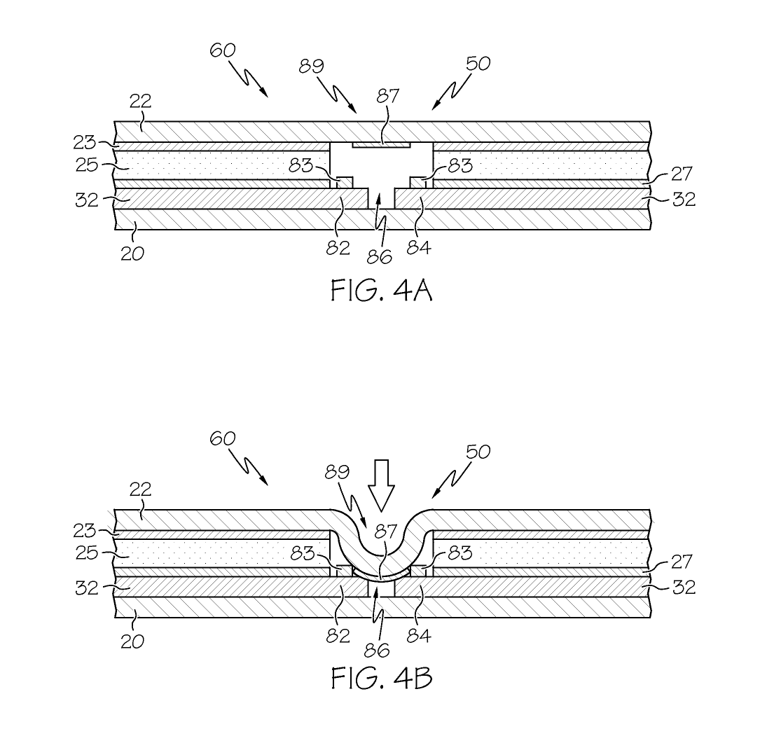

Turning now to FIGS. 4A-4B, yet another embodiment of the irreversible one time switch and circuit activating component is shown in partial sectional view taken along line A-A of FIG. 1. This embodiment of the irreversible one time switch 50 is shown in an open condition 80 in FIG. 4A, and in an irreversibly closed condition 81 in FIG. 4B.

The various substrates 20, 22 and layers 23, 25, 27 previously discussed with regards to FIGS. 2A-2B can be the same, though more or less, similar or different substrates and/or layers can also be used. Also, as before, an open circuit is created by placing a small physical gap 86 between a first portion 82 and second portion 84 of the first independent electrical connection 32 in the circuit that connects to the battery 100. Thus, the physical gap 86 prevents electrical current flow between the first and second portions 82, 84 of the first independent electrical connection 32. Also, above the gap 86 there is an open area extending through the layers, such as through the spacer layer 25 and/or adhesive layers 23, 27.

However, this embodiment provides a construction similar to a membrane switch. Thus, in this embodiment there is no hole or opening through the uppermost layer (i.e., second substrate 22). Instead, a portion of the second substrate 22 (and adhesive layers 23, 25, 27) forms a membrane switch 89 that is resiliently flexible vertically above the physical gap 86.

When the consumer wants to begin using the device, it can be easily activated by depressing the portion of the second substrate 22 forming the membrane switch 89 downward towards the physical gap 86 (see FIG. 4B). The membrane switch 89 is provided with a conductive layer 87 adapted to contact the first and second portions 82, 84 to electrically bridge the physical gap 86. In one example, a conductive layer 87 can be disposed on the second substrate 22 (directly or indirectly), such as on the underside of the second substrate 22. In various examples, the conductive layer 87 can be a metallic foil, a printed ink, or a printed conductive adhesive. In addition or alternatively, a conductive layer 83 can be provided on either or both sides of this physical gap 86 (i.e., on either or both of the first and second portions 82, 84). In various examples, the conductive layer 83 can be a metallic foil, a printed conductive ink, or a printed conductive adhesive. In still yet another example, the conductive layer can comprise a combination of layer 87 and layer 83, one of which providing conductive properties and the other providing adhesive properties.

Thus, upon depressing the second substrate 22 downward towards the physical gap 86, the conductive layer 87 and/or conductive layer 83 permanently and irreversibly maintains the membrane switch 89 in a condition that electrically bridges the physical gap 86 to close the open switch 50. The adhesive force provided by the layers 87 and/or 83 is sufficient to counter the resiliency of the second substrate 22, though it is contemplated that the second substrate 22 may not be resilient. For the consumer's ease of operation, the area on the second substrate 22 about the membrane switch 89 and above the physical gap 86 can be marked with indicia indicating a “switch”. The conductive adhesive(s) (layers 87, 83) ensure an irreversible connection.

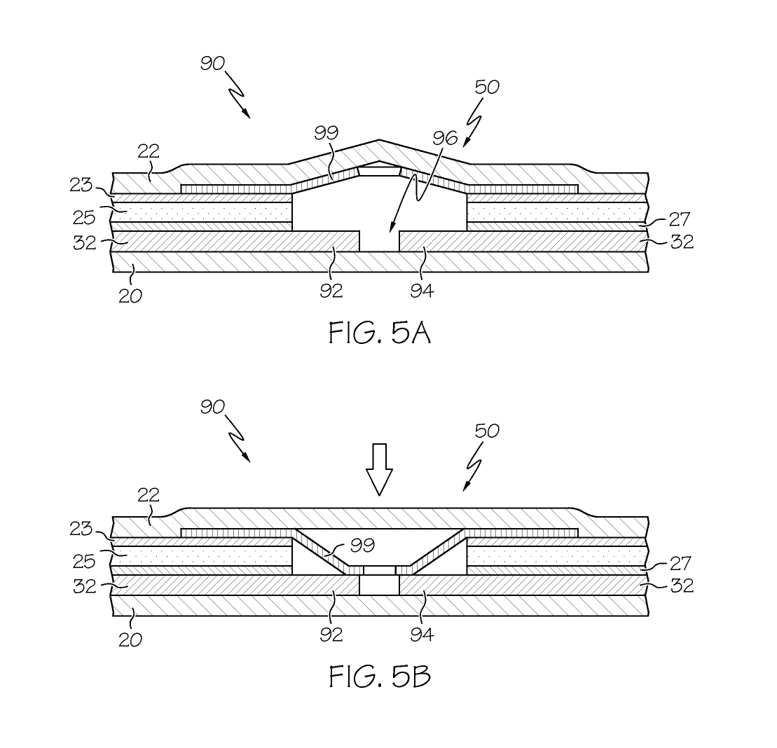

Turning now to FIGS. 5A-5B, still yet another embodiment of the irreversible one time switch and circuit activating component is shown in partial sectional view taken along line A-A of FIG. 1. This embodiment of the irreversible one time switch 50 is shown in an open condition 90 in FIG. 5A, and in an irreversibly closed condition 91 in FIG. 5B.

The various substrates 20, 22 and layers 23, 25, 27 previously discussed with regards to FIGS. 2A-2B can be the same, though more or less, similar or different substrates and/or layers can also be used. Also, as before, an open circuit is created by placing a small physical gap 96 between a first portion 92 and second portion 94 of the first independent electrical connection 32 in the circuit that connects to the battery 100. Thus, the physical gap 96 prevents electrical current flow between the first and second portions 92, 94 of the first independent electrical connection 32. Also, above the gap 96 there is an open area extending through the layers, such as through the spacer layer 25 and/or adhesive layers 23, 27.

In this embodiment, the conductor comprises a conductive, plastically deformable switch 99 to electrically close the open switch 50. As shown in FIG. 5A, the plastically deformable switch 99 is retained between various layers of the assembly, such as between the second substrate 22 and the adjacent adhesive layer 23. The thickness of the plastically deformable switch 99 may cause the second substrate 22 to bulge slightly. Alternatively, the plastically deformable switch 99 could be retained between other layers, or could even be retained solely on a single layer, such as directly onto the underside of the second substrate 22.

When the consumer wants to begin using the device, it can be easily activated by depressing the portion of the second substrate 22 above the plastically deformable switch 99 downward towards the physical gap 96 (see FIG. 5B). The downward force will plastically and irreversibly deform at least a portion of the plastically deformable switch 99 until it contacts the first and second portions 92, 94 of the first independent electrical connection 32. Once deformed, the plastically deformable switch 99 extends across the first and second portions 92, 94 to electrically bridge the physical gap 96. In the shown example, the plastically deformable switch 99 has a generally circular geometry that includes a hollow center hole to facilitate its deformation. Thus, the physical gap 96 is electrically bridged by the electric current flowing through the plastically deformable switch 99. Still, various geometries of the plastically deformable switch 99 are contemplated.

In one example, the plastically deformable switch 99 comprises an irreversible Belleville washer. This washer acts as an irreversible one way switch due to its plastic deformation. Thus, once activated by pressing down on the washer, the circuit cannot be de-activated. In addition or alternatively, a conductive or non-conductive adhesive (not shown) can be provided to facilitate retention of the plastically deformable switch 99.

Additionally, the portion of the second substrate 22 adjacent to the plastically deformable switch 99 may be resilient (as shown), or may also be plastically deformed. For the consumer's ease of operation, the area on the second substrate 22 about the plastically deformable switch 99 and above the physical gap 96 can be marked with indicia indicating a “switch”. In addition or alternatively, the plastically deformable switch 99 can deform a portion of the area second substrate 22 to create a raised bump or the like to ease the consumer's operation.

Example manufacturing schemes will now be discussed. To make the manufacturing process of a cell/battery more efficient and/or achieve greater economies of scale, the cell/battery can be manufactured using a generally continuous web in a reel-to-reel printing process to provide production at high speeds and low cost. An example manufacturing procedure is described in the following paragraphs. In this example procedure, the cell/battery proceeds through numerous stations that are compatible with a high-speed printing press running a roll-to-roll setup. Though not further described herein, the processing and assembly could be integrated with the manufacture of the smart card electric device 10 or elements thereof to be powered by the battery, such as with the electrical component 12, etc.

According to available printing presses, the cells could be made with one pass, or multiple passes, on a given press, for example. As an example, two rows of individual cells on the web; however, the number of rows is limited only to the size of the unit cells and the maximum web width that the press can process. Because there may be numerous steps, thereby likely utilizing a long and complicated press, some of these steps, as well as some of the materials, could be modified and/or multiple passes of a press or multiple presses could be used. Some modified process summaries will be shown after the initial discussion is completed. Moreover, any or all of the printing steps can be performed by screen printing, such as by flat bed screens or even rotary screen stations. Additionally, one skilled in the art would realize that one printing press with more than five stations could be difficult to find and or to operate, and thus the following discussion of the process could occur on one or more presses or even multiple passes through one press.

During manufacturing, various optional operations may or may not occur. For example, the optional operations could include one or both of heat stabilization of the web and graphics printing (which could include logos, contact polarities, printing codes and the addition of registration marks on the outside surface of web). If these optional printing operations occur on the web, then the web can be turned over and the functional inks can be printed on the inside surface, (i.e., the heat seal layer).

One skilled in the art would realize that there are many methods, materials, and sequences of operations that could be used, and that more or less, similar or different, numbers of stations could also be utilized. Still, it is to be understood that the following process can also be utilized for the manufacture of various other integrated electrical devices. Further, for the purposes of clarity only two columns of batteries will be described and illustrated with the understanding that such description can similarly apply to other columns. Moreover, it is to be understood that any or all of the following elements can include any of the various materials, chemical compositions, etc. described throughout this document. Additionally, the various steps are intended to be merely example steps, and it is to be understood that the steps can include various other steps, alternatives, etc. as discussed herein.

As discussed herein, any or all of the substrates can be provided as generally continuous webs that can be processed through a “reel-to-reel” style manufacturing process. For example, a first substrate can be provided as a generally continuous web from a source station, which can be a source roll or the like. Some or all of the various processing steps, such as, for example, the steps of providing said cathode and anode collections, cathode layer, providing said anode layer, contacts, printed circuitry, and some and/or all of the components of the electrical display 12, etc., can then be performed by passing the generally continuous web through a printing station, or even multiple printing stations. In addition or alternatively, the process can be adapted to pass the web through the printing station in multiple passes. Finally, the completed batteries and electrical displays on the generally continuous web can be collected at a take-up station, which can include a collection roll.

The manufacturing process can include various other stages, steps, etc. For example, prior to or after the printing station, the web can pass through an auxiliary station wherein various electrical components be provided. Moreover, any or all of the various layers, substrates, etc. can be provided by supplemental rolls along the process. For example, an additional substrate (i.e., a spacer layer) can be provided by a supplemental roll via a supplemental web. Though described as near the beginning of the printing station, it is to be understood that any or all of the supplemental webs can be provided at various locations along the manufacturing process. In addition or alternatively, waste material, such as release layers or the like, can be removed from as a waste web and taken-up by a waste roll or the like. Various other pre-processing and/or post-processing stations, steps, etc. can also be included. It is to be understood that the various stations, rolls, etc. of the described process can be utilized in various orders, and additional equipment may even be provided (e.g., idler rollers, tension rollers, turn-bars, slit or perforators, etc.) to facilitate the “reel-to-reel” process.

Various other additional steps can be utilized to provide additional structure, features, etc. to the completed battery cells and electrical components. In one example, an outer portion of the device, such as the second substrate “top cover”, can be provided with a method of attaching the battery cells to another object, surface, etc. For example, the second substrate can include a pressure sensitive adhesive, another adhesive layer, a hook-and-loop style fastener, a liquid or hot-melt adhesive, etc. In another example, an outer portion of the battery cells, such as the second substrate “top cover”, can be provided with printed indicia or even a label or the like.

Thin printed flexible batteries can have many potential applications, which can include one or more of the following generally categories as examples:

1. RFID assemblies;

2. Advertising and promotion;

3. Toys, novelties, books, greeting cards, and games;

4. Inventory tracking and control such as (smart RFID tags);

5. Security tags;

6. Condition indicators such as temperature, humidity, etc.;

7. Skin patches that apply iontophoresis or other electrical function for the purpose of drug delivery, wound care, pain management and/or cosmetics;

8. Healthcare products such as smart diapers, incontinence products, etc.; and

9. Smart cards, with an integrated circuit, radio, audio/visual components, etc.

The invention has been described hereinabove using specific examples and embodiments; however, it will be understood by those skilled in the art that various alternatives may be used and equivalents may be substituted for elements and/or steps described herein, without deviating from the scope of the invention. Modifications may be performed to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby.

What is claimed is:

1. An electrical device comprising:
a substrate;
an electrical component on the substrate and an electrical contact;
a battery on or integrating the substrate for providing electrical energy to said electrical component, said flat battery comprising an electrode;
an open switch electrically connected between the electrical contact and the electrode, said switch preventing electrical communication between the electrical contact and the electrode while open; and
a conductor adapted to irreversibly close the open switch to thereby establish a permanent electrical circuit between the electrical contact and electrode.

2. The electrical device of claim 1, wherein the conductor comprises a conductive liquid.

3. The electrical device of claim 2, wherein the conductive liquid comprises a conductive adhesive.

4. The electrical device of claim 2, wherein the conductive liquid comprises a conductive ink.

5. The electrical device of claim 2, wherein the conductive liquid comprises at least one of carbon, silver, copper, gold, nickel, tin, and zinc.

6. The electrical device of claim 1, wherein the conductor comprises a conductive plug.

7. The electrical device of claim 6, wherein the substrate comprises a hole, the open switch is accessible through the hole, and the conductive plug is non-removably inserted into the hole to electrically close the open switch.

8. The electrical device of claim 7, wherein the conductive plug is retained within the hole by a pressure sensitive adhesive.

9. The electrical device of claim 1, wherein the conductor comprises a membrane switch with a conductive layer.

10. The electrical device of claim 9, wherein the conductive layer comprises a conductive adhesive that permanently and irreversibly maintains the membrane switch in a condition that electrically closes the open switch.

11. The electrical device of claim 1, wherein the conductor comprises a conductive, plastically deformable switch to electrically close the open switch.

12. The electrical device of claim 11, wherein the plastically deformable switch comprises a conductive Belleville washer.

13. The electrical device of claim 1, wherein the battery comprises a flat battery that comprises at least one electrochemical cell having a printed electrochemical layer comprising a first dried or cured ink, said printed electrochemical layer being printed on a collector layer comprising a second dried or cured ink, said collector layer being printed on the substrate.

14. The electrical device of claim 13, further comprising an additional electrochemical layer adjacent to said printed electrochemical layer, wherein both said printed electrochemical layer and said additional electrochemical layer are each at least partially covered by an electrolyte layer in contact with both said printed electrochemical layer and said additional electrochemical layer.

15. The electrical device of claim 1, wherein the electrical component comprises at least one of an RFID antenna and a display.

16. An electrical device comprising:
a substrate;
an electrical component on the substrate and an electrical contact;
a flat battery on or integrating the substrate for providing electrical energy to said electrical component, said flat battery comprising an electrode;
an electrical coupler assembly electrically connected between the electrical contact and the electrode, wherein the electrical coupler assembly comprises a physical gap preventing electrical communication between the electrical contact and the electrode; and
a conductor adapted to irreversibly electrically bridge the physical gap to thereby establish a permanent electrical circuit between the electrical contact and electrode.

17. The electrical device of claim 16, wherein the circuit activating component comprises a non-removable conductive liquid.

18. The electrical device of claim 16, wherein the circuit activating component comprises a conductive plug that is non-removably inserted across the physical gap.

19. The electrical device of claim 16, wherein the circuit activating component comprises a membrane switch with a conductive layer to electrically bridge the physical gap.

20. The electrical device of claim 16, wherein the circuit activating component comprises a conductive, plastically deformable switch to electrically bridge the physical gap.

21. An electrical device comprising:
a first substrate;
a second substrate arranged in a covering relationship over at least a portion of the first substrate;
an electrical component on the first substrate and an electrical contact;
a flat battery on or integrating the first substrate for providing electrical energy to said electrical component, said flat battery comprising an electrode;
an open switch electrically connected between the electrical contact and the electrode, said switch preventing electrical communication between the electrical contact and the electrode while open, wherein the open switch is physically accessible via the second substrate; and
a circuit activating component configured to permanently and irreversibly close the open switch to thereby establish a permanent electrical circuit between the electrical contact and electrode.

22. The electrical device of claim 21, wherein the open switch is accessible through a hole of the second substrate.

23. The electrical device of claim 22, wherein the circuit activating component comprises a conductive liquid non-removably inserted into the hole to electrically close the open switch.

24. The electrical device of claim 22, wherein the circuit activating component comprises a conductive plug non-removably inserted into the hole to electrically close the open switch.

25. The electrical device of claim 21, wherein the circuit activating component comprises a membrane switch with a conductive layer provided on the second substrate to electrically close the open switch.

26. The electrical device of claim 21, wherein the circuit activating component comprises a conductive, plastically deformable switch to electrically close the open switch.
